(19) United States
(12) Patent Application Publication
(10) Pub. No.: US 2021/0237545 A1
(43) Pub. Date: Aug. 5, 2021

(54) DOOR PROTECTOR FOR PETS

(71) Applicant: Doug Moldovan, Parma, OH (US)

(72) Inventor: Doug Moldovan, Parma, OH (US)

(21) Appl. No.: 17/149,533

(22) Filed: Jan. 14, 2021

Related U.S. Application Data
(60) Provisional application No. 62/965,354, filed on Jan. 24, 2020.

(51) Int. Cl. B60J 5/04; A01K 29/00

(52) U.S. Cl. CPC B60J 5/0493; A01K 29/00

(57) ABSTRACT

An apparatus for protecting a vehicle door panel from pet damage, including a door protector with a first portion configured for insertion into the vehicle door and a second portion configured for covering a door panel surface exposed to a pet. In this manner, the door protector protects the door panel surface from pet damage when installed over the vehicle door panel. The door protector can be removably inserted between a window glass and the vehicle door panel. The door protector can also be configured for covering a door panel handle exposed to a pet. The door protector can comprise a lite velum plastic for installation rigidity and an ethylene propylene diene monomer for protection. The door protectors can be adjustable and trimmable for universal use. A kit can be provided with protectors for other vehicle surfaces.

### CROSS-REFERENCE TO RELATED APPLICATIONS

This application claims the benefit of U.S. provisional patent application Ser. No. 62/965,354, filed Jan. 24, 2020, (Attorney Docket No. 39522.04000). The contents of the above-identified patent application is fully incorporated herein by reference.

### TECHNICAL FIELD

The disclosure below demonstrates an apparatus, system, and process for improved interior and door protection from pets.

### BACKGROUND OF THE DISCLOSURE

Current vehicle door protector products are limited to a shelf or cover. A hard plastic shelf clicks together to make a 90° shelf for the pet to stand on. A problem is the possibility for the pet to be hurt by the hard pieces, for example, when the car is stopped or turns. Furthermore, nothing keeps the pet from slipping or falling off the shelf.

### BRIEF SUMMARY OF THE DISCLOSURE

In one embodiment, an apparatus for protecting a vehicle door panel from pet damage includes a door protector, comprising a first portion configured for insertion into the vehicle door and a second portion configured for covering a door panel surface exposed to a pet, wherein the door protector protects the door panel surface from pet damage when installed over the vehicle door panel.

Features that are described and/or illustrated with respect to one embodiment may be used in the same way or in a similar way in one or more other embodiments and/or in combination with or instead of the features of the other embodiments.

The descriptions of the invention do not limit the words used in the claims in any way or the scope of the claims or invention. The words used in the claims have all of their full ordinary meanings.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify embodiments of this invention. It will be appreciated that illustrated element boundaries (e.g., boxes, groups of boxes, or other shapes) in the figures represent one embodiment of boundaries. In some embodiments, one element may be designed as multiple elements or that multiple elements may be designed as one element. In some embodiments, an element shown as an internal component of another element may be implemented as an external component and vice versa. Furthermore, elements may not be drawn to scale.

FIG. 1 is a perspective view of an exemplary door protector installed in an exemplary door panel in accordance with one aspect of the disclosed technology.

FIG. 2 is a perspective view of an exemplary door protector installed in an exemplary door panel providing protection from an exemplary pet in accordance with one aspect of the disclosed technology.

FIG. 3 is a cross-section view of an exemplary door protector installed in an exemplary door panel in accordance with one aspect of the disclosed technology.

FIG. 4 is a perspective view of another exemplary door protector installed in an exemplary door panel in accordance with one aspect of the disclosed technology.

FIG. 5 is a perspective view of another exemplary door protector installed in an exemplary door panel providing protection from an exemplary pet in accordance with one aspect of the disclosed technology.

FIG. 6 is a plan view of an exemplary door protector in accordance with one aspect of the disclosed technology.

FIG. 7 is a perspective view of an exemplary vehicle protector set installed in an exemplary vehicle in accordance with one aspect of the disclosed technology.

### DETAILED DESCRIPTION

The following detailed description includes exemplary terms that may be used throughout the disclosure. Both singular and plural forms of all terms fall within each meaning.

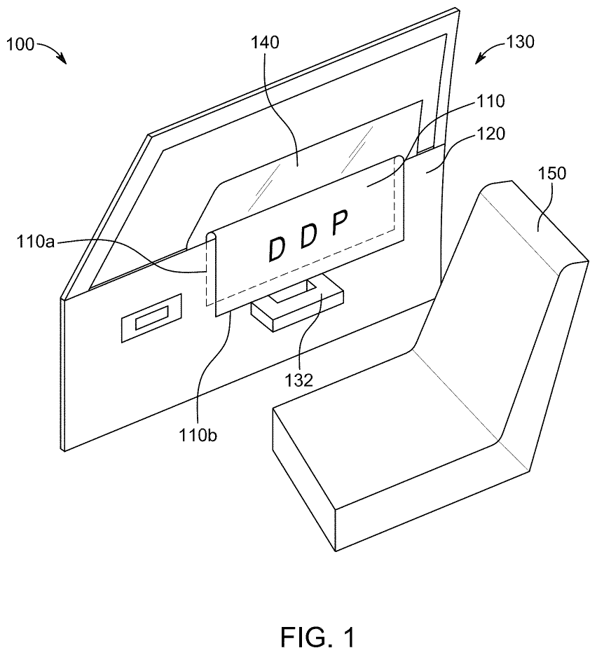

In one embodiment, an exemplary vehicle interior 100 is shown in FIG. 1. As shown, a door protector 110 (labeled with the insignia “DDP” for Doggy Door Pad/Protector) is installed onto an exemplary door panel 120 (with an exemplary door handle/armrest 122) of a vehicle door 130. A first portion of the protector 110a (e.g., plastic) can easily slip/slide into the door 130 between the window glass 140 and the door panel 120. In this manner, a second portion of the protector 110b (e.g., with a soft neoprene pad) can lie relatively flat over (i.e., cover or overlay) the inside of the door panel 120 surface exposed to a pet. In one embodiment, for example, the first portion 110a can be about 20″ wide and 12″ deep and the second portion 110b can be about 24″ wide and 18″ deep. Many other embodiments can include protector 110 portions 110a, 110b with various other dimensions to accommodate various applications, door sizes, etc., including some with adjustable and/or extendable dimensions (e.g., a foldable flap to provide more or less coverage). In various embodiments, the protector 110 can be a one-piece, two-piece/section apparatus with mounting/protective sleeves, for example, of neoprene and plastic that can be used when taking pets for a ride in a vehicle so that the pet can enjoy the window safely without damaging the vehicle door.

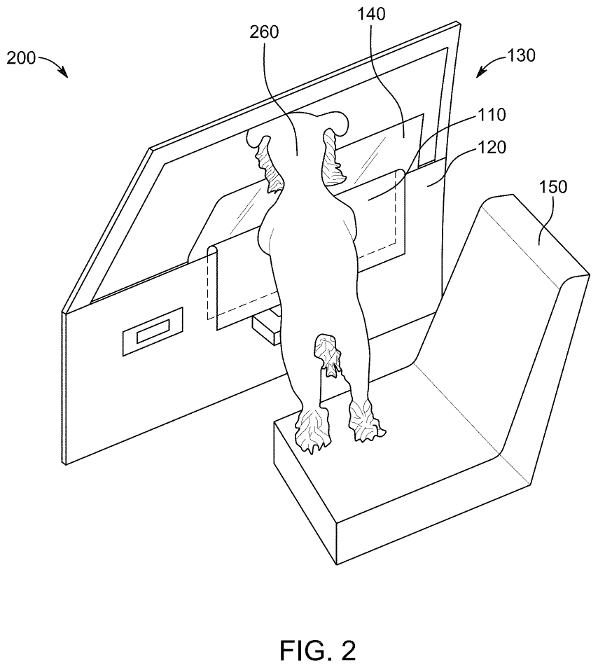

With further additional reference to FIG. 2, embodiment 200 shows exemplary vehicle interior 100 with a pet 260, a vehicle seat 150 is commonly used by pet 260 for support during occupancy and/or rides in the vehicle. While the pet 260 is sitting or standing on the seat 150, the protector 110 can protect the door panel 120, for example, from dirt, drool, soiling, debris, scratches, scuffs, wear, damage, etc., from the pet 260, including, for example, from the pet's feet, paws, mouth, etc. This may be especially important if the pet 260 places its head and/or feet directly on the door panel 120, as shown in FIG. 2.

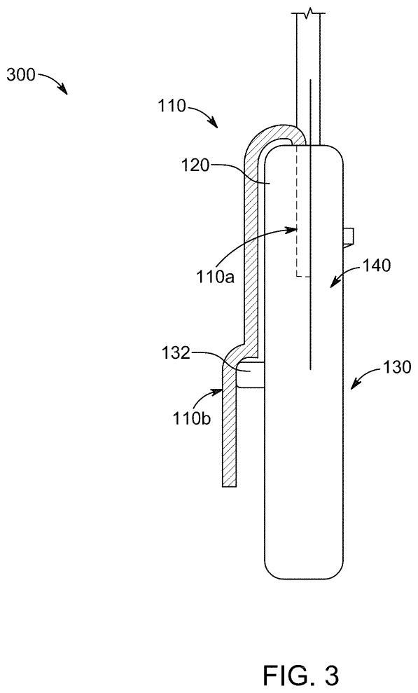

With further additional reference to FIG. 3, embodiment 300 shows a cross-section view of an exemplary protector 100 installed in the door 130. In this embodiment, the exemplary window 140 is partially, for example, about halfway down, a more rigid (e.g., plastic) section 110a of the protector 110 can be inserted between the door panel 120 and the window glass 140. A more flexible (e.g., neoprene) section 110b of the protector 110 can hang down over the inside of the vehicle door 120, protecting the door 120 (trim) and handle/armrest 122 from pet dirt, drool, soiling, debris, scratches, scuffs, wear, damage, etc. The inside/flexible section 110b can also provide for pet traction to minimize/avoid slipping or falling when the vehicle accelerates, stops, and/or turns.

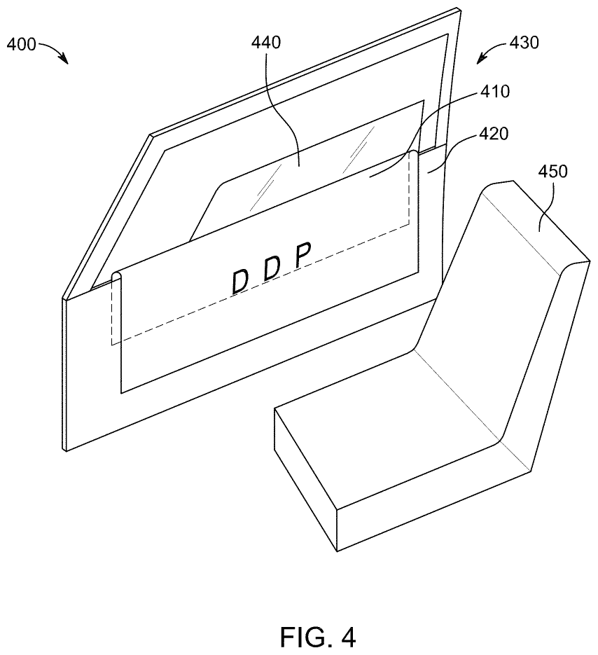

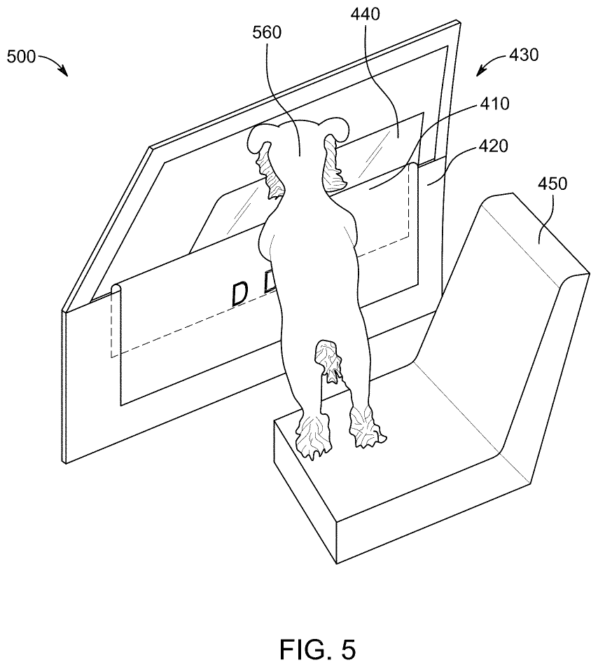

In one embodiment, as shown in FIG. 4, an exemplary vehicle interior 400 is shown with a larger door protector 410 (labeled with the insignia “DDP” for Doggy Door Pad/Protector) installed onto an exemplary door panel 420 of a vehicle door 430 with glass 440. With further additional reference to FIG. 5, embodiment 500 shows exemplary vehicle interior 400 with a pet 560 on vehicle seat 450 with protector 410 protecting the door 420 as described above.

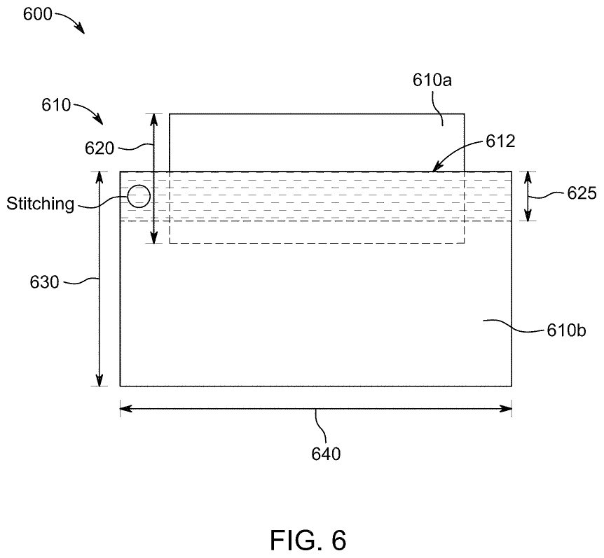

FIG. 6 shows a plan view of an embodiment 600 of an exemplary door protector 610. As shown, a door protector 610 is shown flat before being installed onto a door panel of a vehicle door. A first portion of the protector 610a (e.g., lite velum plastic) can be used to slip/slide onto the panel between the window glass and the door panel when installed. A second portion of the protector 610b (e.g., with a soft neoprene pad) can lie relatively flat over the inside of the door panel when installed. In this exemplary embodiment, a plastic portion having a length 620 (e.g., 12-24″) can comprise the first portion 610a and overlap the second portion 610b for joining the two portions 610a, 610b. When installed, the plastic would bend along axis 612, such that portions 610a, 610b would be inside the door and protecting the door panel, respectively. For example, the plastic and be stitched to the flexible portion in the area 625 (e.g., about 2″). In one embodiment, stitching 625 pinches the lite velum plastic between two pieces of neoprene (e.g., 100% Ethylene Propylene Diene Monomer (EPDM)), which prevents the plastic from scratching the door panel when installed. Portion 610b can have a length 630 (e.g., 16-30″) and a width 640 (30-40″). Many other embodiments can include protector 610 portions 610a, 610b with various other dimensions to accommodate various applications, door sizes, etc., including some with adjustable and/or extendable dimensions (e.g., a foldable flap to provide more or less coverage). In various embodiments, the protector 610 can be a one-piece, two-piece/section apparatus with mounting/protective sleeves.

The door protector (e.g., 110, 410, 610) can be made from any suitable materials that provide suitable sections for securing to the door and for providing protection. Materials may be suitable for various pets and applications. Vary sizes can be utilized based on the application, including, for example, based on the size of the door, the area to be protected, door panel shape, etc. Material durometer and thicknesses for each section can also be selected to be suitable for the purpose of the application. For example, in one embodiment, the more flexible (e.g., neoprene) section protecting the door may be about ⅜″ thick. The more rigid section inserted into the door may be thinner to minimize the required clearance, have enough rigidity to be inserted through the glass opening against the glass, but still flexible enough to conform to the shape of the glass/opening. Thicknesses can also vary or taper to provide easier installation, more protection, etc. in certain areas. Multiple sections can be joined via any suitable process, including, for example, stitching, gluing, molding (including co-molding), heat-staking, etc.

Material variations/properties can also include color (e.g., to match vehicle interior), patterns, words (e.g., imprinted with pet name), anti-microbial properties, hypoallergenic, washable, scented, etc., and can be functional and/or decorative.

Some embodiments include a universal door pad that can be constructed to allow the user to customize the size and/or shape of the door pad to meet the vehicle and/or user needs. For example, in one embodiment, a large or oversized door pad can be provided for cutting/trimming of one or more sections by the user. This embodiment can accommodate various door inside (e.g., where the rigid section would be placed) configurations (e.g., window glass shape, glass track path, glass seal, electronics, wires, pull handle hardware, switch harnesses, etc.) and door outside (e.g., where the flexible section would cover) trim configurations (e.g., glass seal, door trim, window switches, door lock switches, mirror switches, armrest, pull handle/cup, escutcheons, bezels, etc.). In some embodiments, cut-outs can be made to accommodate unique vehicle features (e.g., door lock post on top of door trim).

Some embodiments can include a biased form for easy stowage when not in use. For example, multiple sections can be biased to lay flat against each other when not in use, but have a flexible joint that bends easily during installation into the door panel.

Some embodiments may have more sections/layers/surface treatments suitable for various applications. For example, the more flexible section protecting the door trim can have a top surface/treatment that the pet can contact and a bottom surface/treatment that contacts the door surface. These surfaces/treatments can provide surfaces more suited to the intended contact (e.g., pet feet versus door trim) and have various abrasion/friction/traction characteristics. Similarly, the more rigid section inserted into the door can be smooth on one or more sides for easy installation and actuation/movement of window glass while installed.

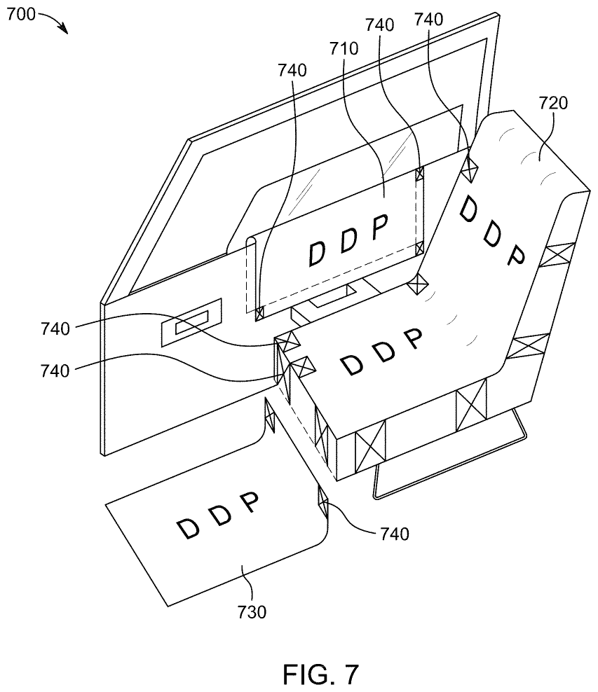

In some embodiments, a matching seat and/or floor protector may also be included as a set or kit, as shown in FIG. 7. In this embodiment, protector set 700 includes a door protector 710, as described above, a seat protector 720, and/or a floor protector 730 (all shown with the DDP insignia). One or more of these pieces 710, 720, 730 can be connected/joined to another piece 710, 720, 730 with attachments 740, which may be, for example, hook-and-loop fasteners. In various other embodiments, other protectors can also be used, including, for example, armrest protectors. In various embodiments, one or more of these protectors can include similar one or two-piece designs as described above for the exemplary door protectors. For example, a one-piece protective covering or a two-piece protector with a rigid portion for securing to the vehicle and softer portion for providing the protective layer. In one embodiment, an armrest protector can be a one-piece design that simply lays over the vehicle armrest. In another embodiment, a seat protector may be a two-piece design that includes a rigid portion for inserting between the seat back and seat bottom and a flexible portion for covering the seat surfaces.

1. An apparatus for protecting a vehicle door panel from pet damage, comprising:
a door protector, comprising:
a first portion configured for insertion into the vehicle door; and
a second portion configured for covering a door panel surface exposed to a pet;
wherein the door protector protects the door panel surface from pet damage when installed over the vehicle door panel.

2. The apparatus of claim 1, wherein the first portion of the door protector is removably inserted between a window glass and the vehicle door panel.

3. The apparatus of claim 1, wherein the second portion of the door protector is further configured for covering a door panel handle or armrest exposed to a pet.

4. The apparatus of claim 1, wherein the first portion of the door protector comprises a lite velum plastic.

5. The apparatus of claim 1, wherein the second portion of the door protector comprises an ethylene propylene diene monomer.

6. The apparatus of claim 1, wherein the first portion of the door protector is stitched to the second portion of the door protector.

7. The apparatus of claim 1, wherein the second portion of the door protector is configured for providing an adjustable area of coverage.

8. The apparatus of claim 1, wherein the first portion of the door protector is configured to be trimmed to fit inside the vehicle door panel.

9. The apparatus of claim 1, wherein the second portion of the door protector is configured to be trimmed to cover the door panel surface.

10. An apparatus for protecting a vehicle door panel from pet damage, comprising:
a universal door protector, comprising:
a first portion configured for insertion into the vehicle door; and
a second portion configured for covering a door panel surface exposed to a pet;
wherein the door protector protects the door panel surface from pet damage when installed over the vehicle door panel, and wherein at least one of the first portion or the second portion is configured to be trimmed to fit the vehicle door panel.

11. The apparatus of claim 10, wherein the first portion of the door protector comprises a lite velum plastic.

12. The apparatus of claim 10, wherein the second portion of the door protector comprises an ethylene propylene diene monomer.

13. A system for protecting a vehicle from pet damage, comprising:
a door protector, comprising:
a first portion configured for insertion into the vehicle door; and
a second portion configured for covering a door panel surface exposed to a pet; and
at least one of a seat protector, a floor protector, or an armrest protector;
wherein the system protects the vehicle from pet damage when installed in the vehicle.

14. The system of claim 13, wherein the first portion of the door protector is removably inserted between a window glass and the vehicle door panel.

15. The system of claim 13, wherein the second portion of the door protector is further configured for covering a door panel handle or armrest exposed to a pet.

16. The system of claim 13, wherein the first portion of the door protector comprises a lite velum plastic.

17. The system of claim 13, wherein the second portion of the door protector comprises an ethylene propylene diene monomer.

18. The system of claim 13, wherein at least two of the door protector, the seat protector, the floor protector, or the armrest protector are connected to each other.

19. The system of claim 13, wherein at least two of the door protector, the seat protector, the floor protector, or the armrest protector are provided in a vehicle protection kit.
